(19) United States
(12) Patent Application Publication
(10) Pub. No.: US 2021/0331546 A1
(43) Pub. Date: Oct. 28, 2021

(54) ROLL STABILIZER AND SENSOR UNIT FOR A ROLL STABILIZER

(71) Applicants: Trafag AG, Bubikon (CH); ZF Friedrichshafen AG, Friedrichshafen (DE)

(72) Inventors: Klaus HASKAMP, Dinkage (DE); Armin GOLLIN, Bermatingen (DE); Markus ENGEL, Engen (DE); Christoph MARS, Damme (DE); Christoph SCHANZ, Frickenhausen (DE); Philipp CÖRLIN, Unterensingen (DE); Philippe KLEMM, Unterensingen (DE)

(21) Appl. No.: 17/270,702

(22) PCT Filed: Apr. 4, 2019
(86) PCT No.: PCT/EP2019/058548

§ 371 Date: Feb. 23, 2021

(30) Foreign Application Priority Data
Aug. 24, 2018 (DE) 10 2018 214 345.5

(51) Int. Cl. B60G 17/019; B60G 21/055; G01L 3/10

(52) U.S. Cl. CPC B60G 17/019; B60G 21/0555; B60G 2400/98; B60G 2202/135; B60G 2401/172; G01L 3/102

(57) ABSTRACT

Disclosed is a roll stabilizer (1) for a motor vehicle, comprising a sensor unit (10), which operates according to the principle of inverse magnetostriction, for acquiring torque (M) acting between stabilizer portions (6a, 6b), characterized in that the sensor unit (10) includes a magnetic field generation device, which preferably comprises a transmitter coil (12) and is used for magnetizing a measurement element (4; 6a) affected by torsional stress during operation, and a plurality of magnetic field detection devices, each of which preferably comprises a receiver coil (13) and which are used for acquiring parameters of the magnetic field of the measurement element (4; 6a). Also disclosed is a corresponding sensor unit (10) for a roll stabilizer (1) of the aforementioned type.

The invention relates to a roll stabilizer for a motor vehicle according to the generic part of claim 1 and to a sensor unit for such a roll stabilizer according to the generic part of claim 15.

From automotive engineering, in particular from chassis technology, it is known to equip motor vehicles with a so-called roll stabilizer. In the simplest version, this is a substantially c-shaped torsion bar spring which is rotatably mounted in the central area with respect to the vehicle body and whose outer opposite ends are each coupled to a wheel suspension. As a result of this design, the roll stabilizer ensures that the chassis of the vehicle is not only laterally inclined on its outer curve side when cornering (due to centrifugal force), but that the wheel on the inside of the curve is also lowered to some degree (copying behavior).

To further increase the stability of the vehicle and also the driving comfort, it is known to design roll stabilizers adjustable. In this case, the roll stabilizer comprises an actuator and is divided into two stabilizer portions that can be rotated relative to each other about an axis of rotation with the aid of said actuator. By this relative rotation of the stabilizer portions, a rolling movement of the vehicle body is produced in a targeted manner, or a rolling movement of the vehicle body caused by external influences is counteracted in a targeted manner. In order to control the actuator as needed, it may be useful to detect a torque acting between the stabilizer portions, especially for incorporating this torque into the closed-loop control of the actuator.

From document DE 10 2011 078 819 A1, an actively adjustable roll stabilizer for a motor vehicle is known which has an actuator for rotating the stabilizer portions arranged between its two stabilizer portions. The roll stabilizer includes a sensor device operating on the principle of inverse magnetostriction for detecting a torque acting between the stabilizer portions. For this purpose, a magnetically coded primary sensor is disposed at a stabilizer portion, and a magnetic field sensor is provided as a secondary sensor that converts changes in the magnetic field of the primary sensor into an electrical signal. The magnetically coded primary sensor is formed by a portion of the stabilizer part. A disadvantage of this is that a magnetic coding must be introduced into the stabilizer portion. Another disadvantage of the measuring method is that the strength of the magnetic coding is subject to external influences (such as mechanical influences like stone impact, vibration or the like, or thermal influences) which may limit the functionality of the sensor device.

It is an object of the present invention to provide a roll stabilizer of the type described above, which is easily adjustable and whose sensor device is less subject to external influences.

This object is achieved by a roll stabilizer with the features of claim 1. This is a roll stabilizer for a motor vehicle with a sensor device operating on the principle of inverse magnetostriction for detecting a torque acting between stabilizer portions, which roll stabilizer is, according to the invention, characterized by the sensor device comprising at least one magnetic field generation device for magnetization of a measurement element affected by torsional stress during operation, and at least one first magnetic field detection device for detecting a first magnetic field parameter that changes due to the stress in the measurement element, and at least one second magnetic field detection device for detecting a second magnetic field parameter that changes due to the stress in the measurement element.

Accordingly, it was initially considered beneficial that the torque acting between the stabilizer portions can be detected in an advantageous way without contact—and thus wear-free—by means of a sensor device which operates according to the principle of inverse magnetostriction. To avoid the above-described drawbacks, the sensor unit in the roll stabilizer according to the invention is provided with a magnetic field generation device for active magnetization, which allows a measurement element to be magnetized which is affected by torsion during operation—such as a housing portion of an actuator arranged between the stabilizer portions or an end region of a stabilizer. Expediently, for this purpose, it is made of magnetizable material. In addition, according to the invention, the sensor unit comprises at least one first and one second magnetic field detection device allowing to detect magnetic field parameters—such as orientation, angle and/or strength—of the magnetic field that is actively generated in the measurement element. According to the principle of inverse magnetostriction, a mechanical stress of the measurement element causes a change in the magnetic field of the measurement element, which change can in turn be detected by the magnetic field detection devices. Active magnetization of the measurement element as provided according to the invention has the advantage that an elaborate (permanent) pre-magnetization of the measurement element is not necessary. Since magnetization takes place actively, for example by means of the magnetic field generation device which comprises said one or more transmitter coils, and thus only exists temporarily in each case, the same is less subject to external influences, and in particular there is no temporal weakening and/or weakening caused by mechanical or thermal influences. The aforementioned object is thus solved. Various constructional designs are conceivable.

Basically it should be noted that the measurement element is a component that is affected by torsional stress during operation of the roll stabilizer. In the case of an adjustable roll stabilizer, this component may be a part of the housing of the actuator. But the measurement element can also be a part of the stabilizer portion that exchanges a torque between the wheel suspensions of the motor vehicle in order to compensate for rolling movements.

According to an advantageous further development of the roll stabilizer, the magnetic field generation device and the first and the second magnetic field detection device are arranged on a sensor unit which is in particular radially spaced from the measurement element and/or are integrated in a sensor housing. By being arranged on a sensor unit, elements such as coils, the magnetic field generation device and the magnetic field detection device can be mounted more easily as an assembly unit. An additional or alternative arrangement in a sensor housing offers the advantage that the respective elements of the magnetic field generation device and the magnetic field detection device, such as coils, magnetic sensor elements, flux amplifying elements, electronic components or the like, are protected against dirt, moisture and the like.

According to a preferred embodiment, it is provided that the sensor device comprises several sensor units. Signals from different sensor units can thus be compared or correlated in order to obtain a more accurate measurement.

In particular, it is preferred to arrange a first and a second sensor unit in different positions relative to the measurement element in order to compensate for local influences.

For example, it is provided that a first sensor unit and a second sensor unit are arranged in diametrically opposite positions with respect to a center of the measurement element. For example, an advantage of an opposite arrangement of sensor units in the interior of a measurement element which is designed for instance as a sleeve or as a part of a sleeve is that one sensor unit points in one direction, e.g. towards the road or ground during operation of the roll stabilizer, and that another sensor unit points in the opposite direction, e.g. towards the vehicle chassis. In the case of an impact on the roll stabilizer, e.g. stone chipping, the signals from both sensor units can be compared with each other. A comparison of the signals can also be advantageous when a part of the roll stabilizer cools down due to splash water, for example. In addition, an amplification of the measurement signal can be achieved with a plurality of sensor units.

In a further embodiment, it is provided that said several sensor units are distributed in a ring shape around the center of the measurement element. This can compensate for local influences at the circumference of the measurement element. The sensor units can be arranged in a ring shape, for example. The sensor units could be arranged around the full inner or outer circumference of the measurement element, for example. This achieves the greatest possible integration over the entire circumference.

The sensor device or the at least one sensor unit thereof could, for example, be also attached to one of the stabilizer portions, e.g. to an arm formed on it, outside the actuator housing or any other sleeve region of the roll stabilizer. It is also possible to arrange the sensor unit on the outside of the sleeve region. Preferably, when one or more sensor units are arranged on the outside, the signals are routed via cables to an interior of the roll stabilizer where actuators or control units or electronic components are located.

In a further possible embodiment, it is provided that a first sensor unit for measuring torsional stress of a first stabilizer portion and a second sensor unit for measuring torsional stress of a second stabilizer portion are provided. For example, one sensor unit could be disposed on each arm of the roll stabilizer. This solution allows to correlate the torques that are measured at the individual stabilizer portions. For example, the two torques of the arms of the roll stabilizer could be checked against each other for plausibility.

In an advantageous design, it is provided that the magnetic field generation device or at least one of several magnetic field generation devices and/or at least one, several or all of the magnetic field detection devices is/are disposed radially inside the measurement element. An arrangement in the interior of the measurement element advantageously protects these devices against external influences.

Alternatively, it is provided that the magnetic field generation device or at least one of several magnetic field generation devices and/or at least one, several or all of the magnetic field detection devices is/are arranged radially outside the measurement element. It also possible that the some of the devices or elements thereof are arranged radially inside and others of the devices or elements thereof are arranged radially outside.

In one design, it is provided that the sensor unit has a surface, in particular a convex surface, which is substantially complementary to the inner side of the measurement element.

In one design, it is provided that the sensor device includes at least one third magnetic field detection device for detecting a third magnetic field parameter that changes as a result of stress in the measurement element, and at least one fourth magnetic field detection device for detecting a fourth magnetic field parameter that changes as a result of stress in the measurement element. More precise torque values can be obtained by comparing, processing or correlating the signals which correspond to the first to fourth magnetic field parameters.

In one design, it is provided that the magnetic field generation device comprises at least one transmitter coil. The magnetic field generation device can also comprise a coil package.

The magnetic field detection devices can have a different structure, depending on the magnetic field parameters to be detected. For example, each of the magnetic field detection devices can have at least one Hall sensor. In an advantageous design, it is provided that the magnetic field detection devices each have at least one receiver coil.

In a preferred design, the sensor devices includes at least one first and one second receiver coil. These serve for acquiring parameters of the magnetic field of the measurement element. The sensor device also includes a transmitter coil for generating the magnetic field so that the measurement element is temporarily magnetizable in a touch-free manner only if the transmitter coil is energized. If the transmitter coil is energized for a short time, energy can be saved. In addition, temporary magnetization prevents permanent magnetization, which in turn reduces falsification of measurement results. The transmitter coil can be selectively supplied with direct current or alternating current. If direct current is supplied, a constant magnetic field is generated which makes it easier to evaluate the measurement results. Supplying alternating current prevents the measurement element from becoming magnetized in the course of time and from remaining magnetized even if no measurement is carried out.

Advantageously, the sensor device comprises several receiver coils. Accuracy and/or quality of the measurement can be improved if several receiver coils are used. For example, in an advantageous manner, the transmitter coil can be arranged between at least two receiver coils. In particular, such an arrangement can compensate for a bending influence with appropriate evaluation. In a particularly preferred design, the sensor device comprises four receiver coils.

Advantageously, several receiver coils are positioned relative to each other in such a way that they form a polygon, in particular a square, in the center of which the transmitter coil is arranged. As a result, said several receiver coils each have an equal distance to the transmitter coil so that the receiver coils measure an equal strength of the magnetic field. In this way, a bending influence in particular can be compensated for with appropriate evaluation.

It is also advantageous if the sensor device comprises a control unit which is electrically connected to the transmitter coil and the receiver coils. In this manner, the control unit can drive the transmitter coil. Expediently, the control unit receives a measurement signal from the receiver coils which carries information about the magnetic field. Based on this information, the control unit can calculate the torsion of the measurement element.

Advantageously, the control unit is designed in such a way that the transmitter coil can be energized by it during a time window in order to temporarily generate the magnetic field. For this purpose, the control unit can comprise a power source which can supply the current for the transmitter coil. Additionally or alternatively, the control unit can also drive an external power source to supply current to the transmitter coil. The time window can be within a range of several milliseconds, for example. In this case, the transmitter coil generates a magnetic field for a few milliseconds.

Additionally or alternatively, the control unit can be designed in such a way that a signal from said at least one receiver coil is receivable by it within said time window. When the receiver coils also measure the magnetic field for a few milliseconds, the torsion can be measured in this way with a sufficient time resolution. Further, the control unit can be designed in such a way that it energizes the transmitter coil for this time window and/or in such a way that it can measure the magnetic field parameters by means of the receiver coils.

Furthermore, the control unit cannot apply current to the transmitter coil after the time window for a resting phase. In this manner, permanent magnetization of the measurement element can be avoided.

Concerning the structural design, various arrangements of the sensor device provided according to the invention are conceivable. In an advantageous manner, the transmitter coil and/or the at least one receiver coil can be arranged radially inside the measurement element. In this case, the measurement element provides protection for the coils against external influences. In addition, a compact design of the roll stabilizer can thus be realized.

To achieve high-quality measurement results, the sensor unit expediently has a surface which is essentially complementary to the inside of the measurement element, in particular a convex surface.

Alternatively or additionally, the transmitter coil and/or the at least one receiver coil can be disposed radially outside the measurement element. Such an arrangement can be useful if there is insufficient space inside the measurement element to accommodate a coil.

In an advantageous design, it is provided that the sensor device has at least one shielding device for shielding the at least one magnetic field generation device and the magnetic field detection devices from magnetic field influences. For example, at least one sensor unit is provided with a shielding device. In particular, the at least one sensor unit can have a housing or enclosure made of a material shielding against magnetic fields. In this way, interference of the signal by external disturbing magnetic fields can be avoided or reduced.

Advantageously, the at least one sensor unit comprises a shielding to protect the sensor unit against occurring large electromagnetic disturbances, for example due to the operation of the actuator.

In an advantageous design, the sensor device can additionally comprise an acceleration sensor. For example, a 3-axis acceleration sensor (MEMS sensor) can be additionally implemented in the sensor device. The signal from the acceleration sensor can be used to correlate fast acceleration with the torque signal. This information can be used if, for example, a stone chip generates very fast and high torque information that must be intercepted.

The above-mentioned object is also achieved by a sensor device for a roll stabilizer of a motor vehicle according to the features of claim 14. This is a sensor device for the detection of a torque acting between stabilizer portions on the basis of inverse magnetostriction which is characterized by a magnetic field generation device which comprises e.g. a transmitter coil and is used for magnetizing a measurement element affected by torsional stress during operation, and a first magnetic field detection which comprises e.g. a first receiver coil and is used for detecting a first parameter of the magnetic field of the measurement element which changes as a result of the stress in the measurement element, and a second magnetic field detection device which comprises e.g. a second receiver coil and is used for detecting a second parameter of the magnetic field which changes as a result of the stress in the measurement element. Regarding the further design and the advantages that can be achieved with it, reference is made to the explanations already given on the roll stabilizer.

Embodiments of the invention will be described in the following with reference to the attached drawings from which further features and advantageous effects of the embodiments of the invention are apparent. In the drawings it is shown by:

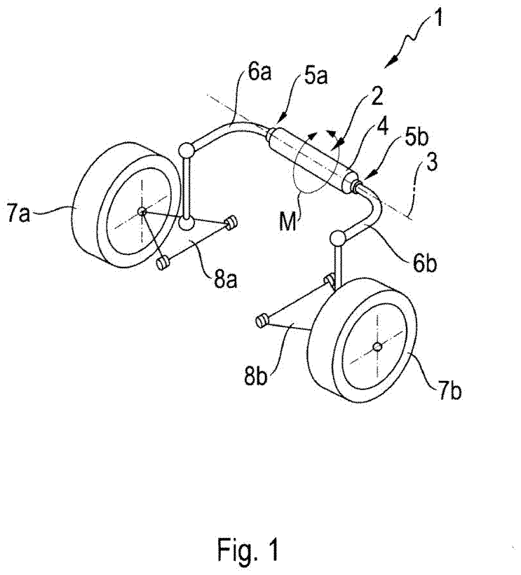

FIG. 1 an adjustable roll stabilizer of a motor vehicle in schematic view;

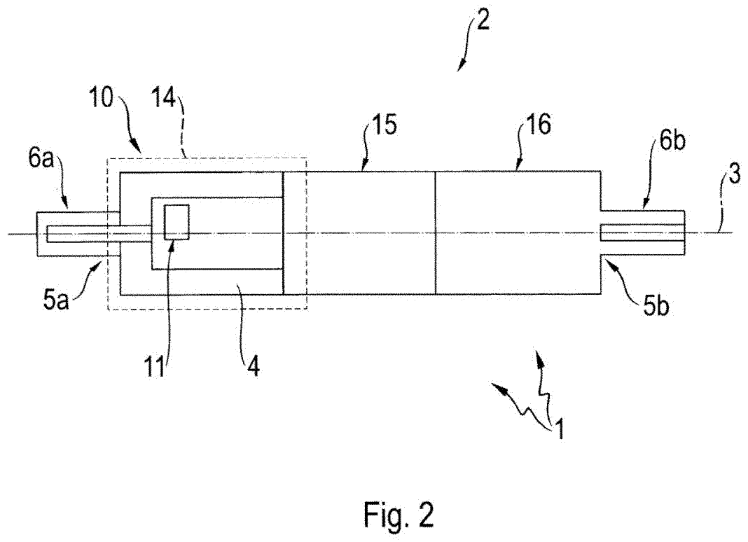

FIG. 2 a simplified schematic representation of a roll stabilizer with measurement inside the actuator housing, in accordance with one embodiment of the invention;

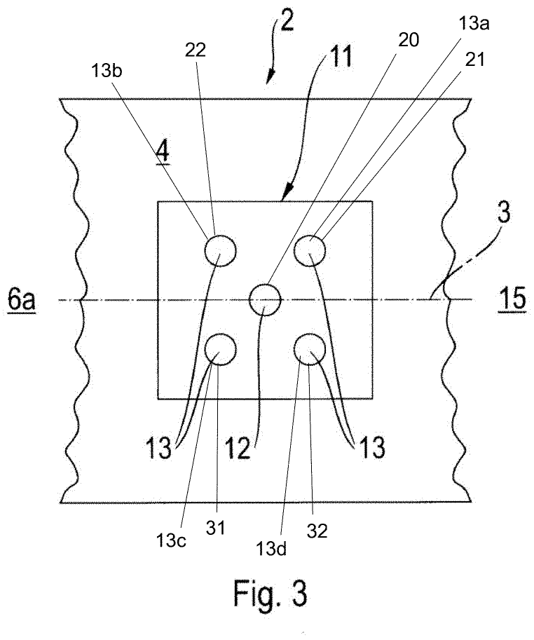

FIG. 3 a simplified schematic representation of a sensor unit in a plan view of a housing;

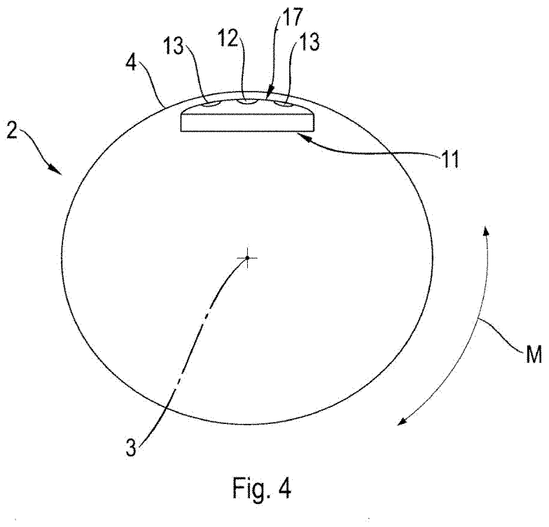

FIG. 4 a simplified schematic representation of a sensor unit in an axial section through an actuator housing;

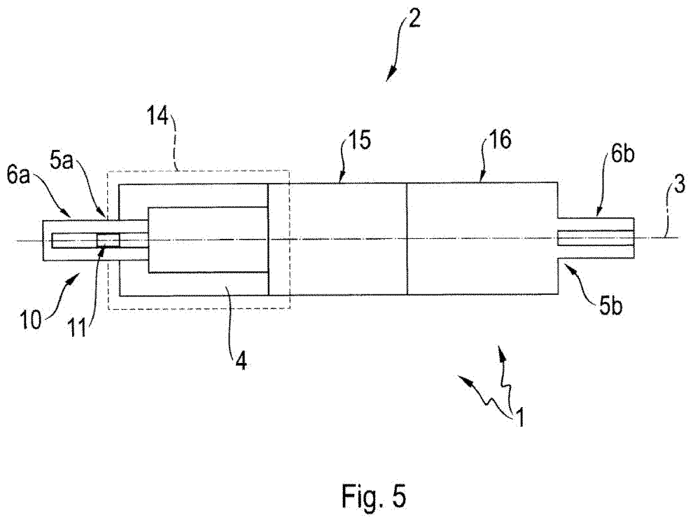

FIG. 5 a simplified schematic representation of a roll stabilizer with measurement inside the stabilizer portion, in accordance with one embodiment of the invention;

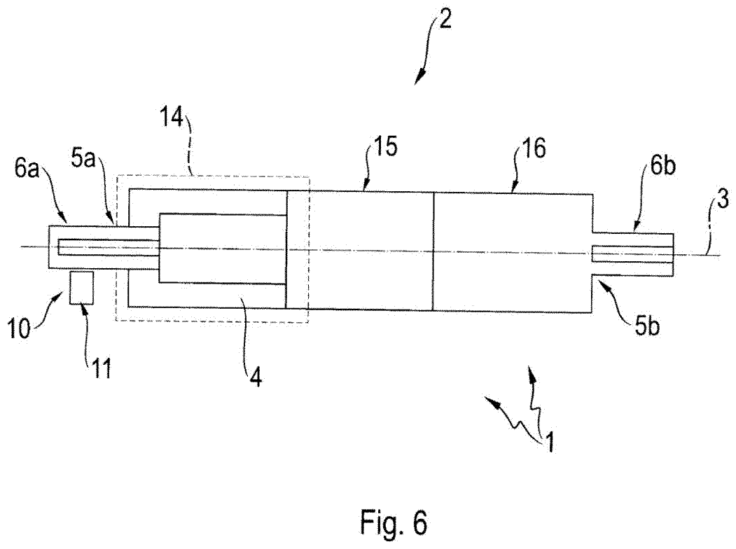

FIG. 6 a simplified schematic representation of a roll stabilizer with measurement outside the stabilizer portion, in accordance with one embodiment of the invention;

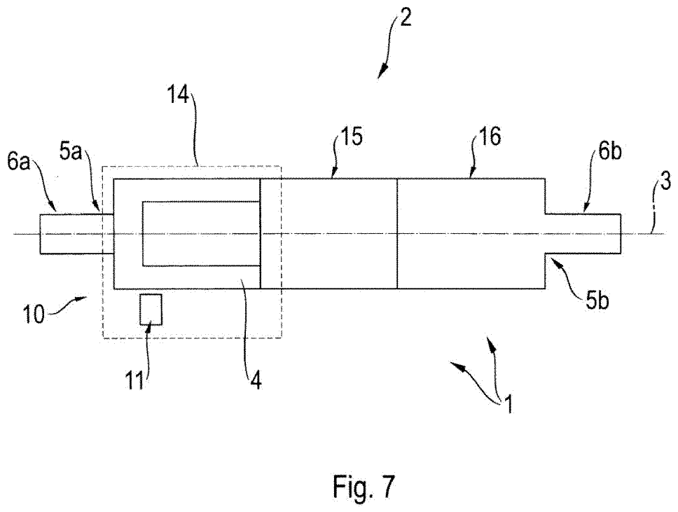

FIG. 7 a simplified schematic representation of a roll stabilizer with measurement outside the stabilizer housing, in accordance with one embodiment of the invention;

FIG. 8 a simplified schematic representation of a roll stabilizer with measurement inside two stabilizer portions, in accordance with one embodiment of the invention;

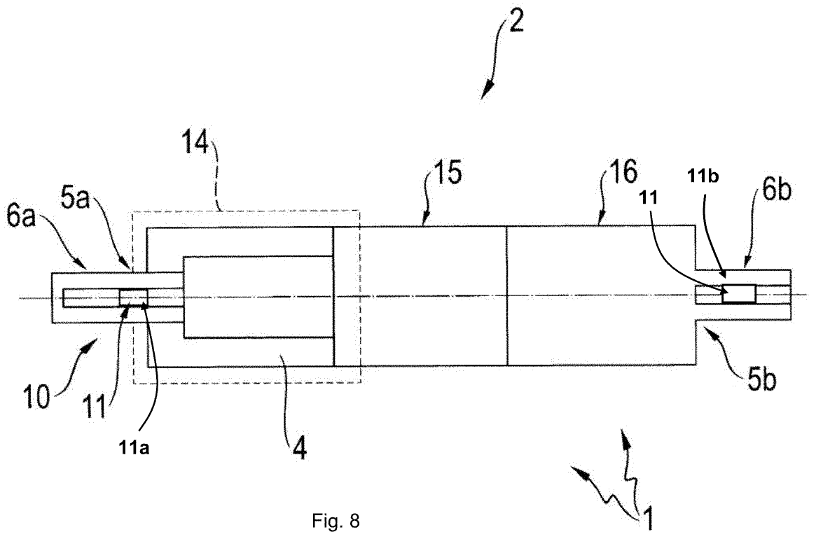

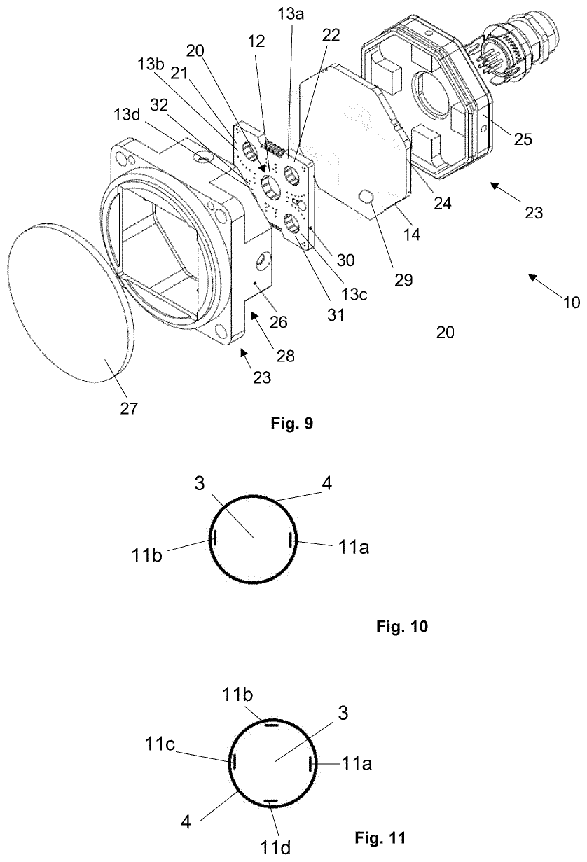

FIG. 9 an exploded view of one embodiment of a sensor unit;

FIG. 10 a simplified schematic representation of the section through the actuator housing of the roll stabilizer, with measurement inside the actuator housing by means of several sensor units at different positions;

FIG. 11 a simplified schematic representation of a section through the actuator housing, with measurement inside the actuator housing by means of sensor units distributed around the inner circumference of the actuator housing.

To illustrate the field of application of the invention, FIG. 1 first shows an adjustable roll stabilizer 1 for a motor vehicle in a simplified schematic perspective view. The adjustable roll stabilizer 1 is part of a chassis of a motor vehicle (not shown). A first wheel 7a and a second wheel 7b on the opposite side of the vehicle are each connected to the vehicle body via a wheel suspension 8a or 8b (shown in simplified form). The wheel 7a and wheel suspension 8a or the wheel 7b and wheel suspension 8b are respectively coupled to an outer end of an associated stabilizer portion 6a or 6b of the adjustable roll stabilizer 1. Both stabilizer portions 6a and 6b are connected to each other centrally of the vehicle via an actuator 2.

The adjustable roll stabilizer 1 is supported to be rotatable about an axis of rotation 3 relative to the vehicle body in a manner known per se (bearing not shown in detail). The actuator 2, shown in simplified form as a cylindrical body, essentially comprises an actuator housing 4 which is rotationally symmetrical with respect to the axis of rotation 3 and in which an electric motor 15 as well as a multistage planetary gear are arranged (both are not shown in this representation; cf. FIGS. 2, 5, 6 and 7). The stabilizer portions 6a and 6b are drivingly connected via the electric motor and the multistage planetary gear. At a standstill of the electric motor, both stabilizer portions 6a, 6b are rigidly connected to each other via the actuator 2. By the operation of the electric motor, the stabilizer portions 6a, 6b can be rotated relative to one another, depending on the direction of rotation about the axis of rotation 3. This is how the adjustable roll stabilizer 1 can be adjusted in a manner known per se.

According to the schematic representation shown, the stabilizer portion 6a is fixed to the housing, which means that it is connected to one end 5a of the actuator housing 4 in a rotationally fixed manner. On the other hand, the stabilizer portion 6b is connected to the actuator 2 at its output end 5b. That is, the stabilizer portion 6b is rotatably mounted relative to the actuator housing 4, but is drivingly connected to the transmission output of the actuator 2. Depending on the operating condition of the motor vehicle, a torque M acts between the stabilizer portions 6a, 6b, which is indicated in FIG. 1 as a double arrow acting about the axis of rotation 3. The amount and direction of the torque M depend on the operating condition.

FIGS. 2, 5, 6, 7, 8 and 10 and 11 show four examples of roll stabilizers according to the invention in a clearly simplified form with regard to the arrangement of the sensor device. First of all, the common features of the roll stabilizers shown there should be discussed:

Each of the roll stabilizers 1 shown in the FIGS. 2 and 5 to 8 and 10 to 11 has a sensor device 10 that works according to the principle of inverse magnetostriction. For reasons of simplification, the stabilizer portions 6a, 6b are shown in a shortened and simplified form as stubs which extend along the axis of rotation 3. The actuator 2 located between them, which interconnects the stabilizer portions 6a, 6b in a manner similar to that shown in FIG. 1, comprises an electric motor 15 and a multistage planetary gear 16 arranged coaxially with the electric motor, and both the electric motor and the multistage planetary gear together with an ECU 14 (electronic control unit) are arranged inside an actuator housing 4. As already discussed in connection with FIG. 1, the stabilizer portion 6a is rigidly connected to the actuator housing 4, whereas the stabilizer portion 6b is rotatably mounted relative to the actuator housing 4 and is connected to the output of the multistage planetary gear 16 in a rotationally fixed manner to be rotatable relative to the stabilizer portion 6a by means of the actuator 2. One end 5a of the actuator, which is fixed to the housing, is also connected to the stabilizer portion 6a, whereas on the output end 5b of the actuator, the stabilizer portion 6b is rotatably mounted relative to the actuator housing 4 and is drivingly connected to the multistage planetary gear 16 and the electric motor 15.

In the explanations given so far for FIG. 2, the embodiment shown in FIG. 2 is similar to the embodiments shown in FIGS. 5, 6 and 7. In order to avoid repetition, the following will therefore only deal with the differing special features of the individual embodiments:

In the roll stabilizer shown in FIG. 2, the sensor device 10 is designed in such a way that a sensor unit 11, for example in the form of a sensor head, is arranged inside the actuator housing 4, the actuator housing 4 also serving as the measurement element of the sensor device 10. The sensor unit 11 is thus arranged radially inside the measurement element 4 (equal to actuator housing 4). The actuator housing 4 can be magnetized by means of a magnetic field generation device arranged on the sensor unit 11, and parameters of the magnetic field generated by the actuator housing 4 can be acquired by means of a first magnetic field detection device and a second magnetic field detection device on the sensor unit 11.

FIGS. 3 and 4 schematically show the structure and arrangement of the sensor unit 11 used in this case in different views. FIG. 9 shows an exploded view of an embodiment of the sensor unit 11.

FIG. 3 shows the sensor unit 11 arranged inside the actuator housing 4 in a simplified form in a plan view. In plan view, the sensor unit 11 is located approximately centrally above the axis of rotation 3 of the actuator 2, in an area between the stabilizer portion 6a and the electric motor 15. A transmitter coil 12 and four receiver coils 13 are arranged on the sensor unit 11 as a structural unit. In this case, the transmitter coil 12 is arranged between a respective pair of receiver coils 13, the four receiver coils 13 being arranged in a square in the center of which the transmitter coil 12 is positioned.

According to FIG. 4, which shows the sensor unit 11 inside the actuator housing 4 of the actuator 2 in axial section along the axis of rotation 2, the sensor unit 11 has a surface 17 that is convex to the inside of the measurement element (equal to actuator housing 4). The coils 12, 13 arranged on the surface 17 thus have an equal distance to the actuator housing 4, whereby for each of the coils there is a similar interaction with respect to the actuator housing 4 serving here as measurement element.

The embodiments shown in FIGS. 5, 6, 7, 8, 10 and 11 differ from the embodiment described on the basis of FIG. 2 with regard to the arrangement of the sensor units 11.

According to the embodiment shown in FIG. 5, the sensor unit 11 is arranged radially inside the stabilizer portion 6a. In this case, the stabilizer portion 6a forms the measurement element—at least in sections—in that the stabilizer portion 6a can be magnetized by means of the transmitter coil and the magnetic field generated by the stabilizer portion 6a can be detected by means of the receiver coil(s).

According to the embodiment shown in FIG. 6, the sensor unit 11 is arranged radially outside the stabilizer portion 6a. Here, too, the stabilizer portion 6a forms the measurement element—at least in sections—in that the stabilizer portion 6a can be magnetized by means of the transmitter coil and the magnetic field generated by the stabilizer portion 6a can be detected by means of the receiver coil(s).

According to the embodiment shown in FIG. 7, the sensor unit 11 is arranged radially outside the actuator housing 4, which in this case again forms the measurement element. In contrast to the example shown in FIG. 2, however, the sensor unit 11 is now arranged radially outside the actuator housing 4. Such an arrangement can be useful, for example, if there is insufficient space inside the actuator housing 4 to accommodate the sensor unit 11.

FIGS. 8, 10 and 11 show embodiments of the roll stabilizer in which the sensor device 10 has several sensor units 11.

According to the embodiment shown in FIG. 8, a first sensor unit 11 a is arranged radially inside the first stabilizer portion 6a to measure a torque at the first stabilizer portion 6a. A second sensor unit 11b is arranged radially inside the second stabilizer portion 6b to measure a torque at the second stabilizer portion 6b. The sensor device 10, and in particular the control unit 14, is adapted to compare and correlate the signals from the sensor units 11a, 11b.

In the embodiment of FIG. 10, a first sensor unit 11 a and a second sensor unit 11b are arranged radially inside the actuator housing 4 with respect to the center of the actuator housing 4 formed by the rotation axis 3 at diametrically opposite positions. For example, a first sensor unit 11 a points toward a portion of the actuator housing 4 directed toward a ground, while the second sensor unit 11b points toward a side of the actuator housing 4 directed toward the interior of the motor vehicle. If these different areas are influenced differently, for example by external influences such as spray water or the like, a more accurate signal can be achieved by comparing and checking the plausibility of the signals from the sensor units 11a, 11b.

According to the embodiment shown in FIG. 11, several sensor units 11, in this case for example a first to fourth sensor unit 11a-11d, are distributed over the circumference of the measurement element—for example the actuator housing 4.

In the following, an example of the sensor devices 10 or sensor units 11, 11a-11d that can be used in the different embodiments of the roll stabilizer shown here is explained in more detail on the basis of the illustration of FIG. 9.

The sensor unit 11 has a magnetic field generation device 20 as well as a first magnetic field detection device 21 and a second magnetic field detection device 22, a housing 23, an electronic unit 24 and a cover 27.

The housing 23 has a housing bottom 25 and a housing wall portion 26 formed of electrically conductive, magnetically shielding materials. The cover 27 is made of a material such as plastic, which allows magnetic fields to pass well. A shielding device 28 is formed by the housing 23 made of magnetically shielding materials.

The electronic unit 24 has, in particular, the control unit 14 (ECU) and, in the illustrated example, also an acceleration sensor 29.

The magnetic field generation device 20 has the transmitter coil 12. In alternative embodiments, the magnetic field generation device 20 has a plurality of transmitter coils 12 as a coil package (not shown).

The first magnetic field detection device 21 has a first receiver coil 13a. The second magnetic field detection device 22 has a second receiver coil 13b. The first and second receiver coils 13a, 13b and the transmitter coil 12 may be arranged together in an integrated manner in a coil package 30. In an embodiment not shown in more detail here, the coil module 30 has only two receiver coils 13a, 13b. The illustrated embodiment shows the arrangement with four receiver coils 13a-13d already discussed with reference to FIG. 3. The third receiver coil 13c and the fourth receiver coil 13d form a third magnetic field detection device 31 and a fourth magnetic field detection device 32, respectively.

Instead of the receiver coils 13, 13a-13d, other magnetic field detection elements, such as Hall sensors, can also be used in further embodiments not shown in more detail here. Such magnetic field detection elements are used to acquire parameters of the magnetic field. For example, an orientation and an angle of the magnetic field can be acquired by comparing the signals from the individual magnetic field detection devices 21, 22, 31, 32. Through these signals, a torque on the actuator housing 4 or the stabilizer portions 6a, 6b can be detected.

### LIST OF REFERENCE SIGNS

1 roll stabilizer
2 actuator
3 axis of rotation
4 actuator housing
5a end of actuator fixed to housing
5b output end of actuator
6a stabilizer portion (fixed to housing)
6b stabilizer portion (at output side)
7a, 7b wheel
8a, 8b wheel suspension
10 sensor device
11 sensor unit
12 transmitter coil
13 receiver coil
13a first receiver coil
13b second receiver coil
13c third receiver coil
13d fourth receiver coil
14 ECU
15 electric motor
16 multistage planetary gear
17 surface
20 magnetic field generation device
21 first magnetic field detection device
22 second magnetic field detection device
23 housing
24 electronic unit
25 housing bottom
26 housing wall part
27 cover
28 shielding device
29 acceleration sensor
30 coil component
31 third magnetic field detection device
32 fourth magnetic field detection device
M torque

1. A roll stabilizer (1) for a motor vehicle, comprising a sensor unit (10), which operates according to the principle of inverse magnetostriction, for acquiring a torque (M) acting between stabilizer portions (6a, 6b), characterized in that the sensor device (10) includes at least one magnetic field generation device (20) for magnetizing a measurement element (4; 6a) affected by torsional stress during operation, and at least one first magnetic field detection device (21) for acquiring a first magnetic field parameter that changes as result of the stress in the measurement element (4; 6a), and at least one second magnetic field detection device (22) for acquiring a second magnetic field parameter that changes a result of the stress in the measurement element (4; 6a).

2. The roll stabilizer according to claim 1, characterized in that the magnetic field generation device (20) and the magnetic field detection devices (21, 22, 31, 32) are arranged on a sensor unit (11) which is spaced in particular radially from the measurement element (4; 6a) and/or are integrated into a sensor housing.

3. The roll stabilizer according to claim 2, characterized in that the sensor device (10) comprises several sensor units (11, 11a, 11b).

4. The roll stabilizer according to claim 3, characterized in that
4.1 a first sensor unit (11a) and a second sensor unit (11b) are arranged at diametrically opposite positions with respect to a center (3) of the measurement element (4; 6a) or
4.2 said several sensor units (11) are distributed in a ring shape around the center (3) of the measurement element (4; 6a) or
4.3 a first sensor unit (11a) is arranged for measuring torsional stress of a first stabilizer portion (6a), and a second sensor unit (11b) is arranged for measuring torsional stress of a second stabilizer portion (6b).

5. The roll stabilizer according to any of the preceding claims, characterized in that
5.1 the magnetic field generation device (20) or at least one of several magnetic field generation devices and/or at least one, several or all of the magnetic field generation devices (21, 22, 31, 32) are arranged radially inside the measurement element (4; 6a) and/or
5.2 the magnetic field generation device (20) or at least one of several magnetic field generation devices (21, 22, 31, 32) and/or at least, one, several or all of the magnetic field generation devices are arranged radially outside the measurement element (4; 6a).

6. The roll stabilizer according to any of the preceding claims, characterized in that the sensor unit (11) has a surface (17), in particular a convex surface, which is substantially complementary to the inner side of the measurement element.

7. The roll stabilizer according to any of the preceding claims, characterized in that sensor device (10) includes at least one third magnetic field detection device (31) for detecting a third magnetic field parameter that changes as a result of the stress in the measurement element (4; 6a), and at least one fourth magnetic field detection device (32) for detecting a fourth magnetic field parameter that changes as a result of the stress in the measurement element (4; 6a).

8. The roll stabilizer according to any of the preceding claims, characterized in that the magnetic field generation device (20) comprises at least one transmitter coil (12) and/or in that the magnetic field detection devices (21, 22, 31, 32) each comprise at least one receiver coil (13).

9. The roll stabilizer according to claim 8, characterized in that the transmitter coil (12) is arranged between at least two receiver coils (13).

10. The roll stabilizer according to any of claim 8 or 9, characterized in that several receiver coils (13) are positioned relative to each other in such a way that they form a polygon, in particular a square, in the center of which the transmitter coil (12) is arranged.

11. The roll stabilizer according to any of claims 8-10, characterized in that the sensor device (10) comprises a control unit (14) which is electrically connected to the transmitter coil (12) and the receiver coils (13) and with which, for the temporary generation of a magnetic field, the transmitting coil (12) can be energized during a time window and/or with which a signal from the receiving coils (13) can be received within this time window.

12. The roll stabilizer according to any of the preceding claims, characterized in that the sensor unit (10) has at least one shielding device (28) for shielding the at least one magnetic field generation device (20) and the magnetic field detection devices (21, 22, 31, 32) from external magnetic field influences.

13. The roll stabilizer according to any of the preceding claims, characterized by an acceleration sensor (29).

14. A sensor device (10) for a roll stabilizer (1) of a motor vehicle, in particular for a roll stabilizer according to any of the preceding claims, for acquiring torque (M) acting between stabilizer portions (6a, 6b) according to the principle of magnetostriction, characterized by a magnetic field generation device (20) for magnetizing a measurement element (4; 6a) affected by torsional stress during operation, and a first magnetic field detection device (21) for acquiring a first magnetic field parameter that changes as a result of the stress in the measurement element (4; 6a), and a second magnetic field detection device (22) for acquiring a second magnetic field parameter that changes as a result of the stress in the measurement element (4; 6a).
